(19) United States
(12) Patent Application Publication
(10) Pub. No.: US 2006/0072149 A1
(43) Pub. Date: Apr. 6, 2006

(54) Universal document exchange system and method

(76) Inventor: Jim Justice, San Francisco, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/197,461

(22) Filed: Aug. 3, 2005

Related U.S. Application Data
(60) Provisional application No. 60/598,485, filed on Aug. 3, 2004.

(51) Int. Cl. G06F 3/12

(52) U.S. Cl. 358/1.15

(57) ABSTRACT

A universal document exchange system and method provides a document exchange service to a user.

### RELATED APPLICATIONS/PRIORITY CLAIM

This application claims priority under 35 USC §119(e) and 35 USC §120 from U.S. provisional patent application Ser. No. 60/598,485 filed on Aug. 3, 2004 and entitled “Universal Document Exchange (UDX)” which is incorporated herein by reference.

### FIELD OF THE INVENTION

The invention is related to a system and method for document exchange and in particular to a computer-based system and method for electronic facsimile document exchange.

### BACKGROUND OF THE INVENTION

There are conventional systems and solutions that permit a user to send an electronic facsimile. Current Internet FAX (i-FAX) solutions enable a user to send higher quality faxes much faster than standard T.30 telephone-line based machines. This includes high quality color faxes. Current i-FAX solutions also allow users to bypass expensive telephone company expenses for dedicated lines and long distance charges. The major problem with current i-FAX technology (T.37 Type) is that it uses the current internet email system as an operational layer for sending and receiving documents, resulting in difficult machine setup and very poor usability.

In a conventional T.37 Fax system, the sender sends a document via a conventional analog fax machine to a target phone number (DID) used by the recipient to receive faxes. The phone number directs the analog phone call made by the sender's machine to a fax modem, usually part of a larger modem bank, which receives the analog transmission. A computer (server) associated with the modem, assimilates the incoming T.30 (typical) fax transmission data stream and converts it to a TIFF file format (usually using ITU standards Group 3 or Group 4). This file is then automatically forwarded by the server to an email address associated with the target phone number (usually in a database at the server). The primary advantage with this method is that the receiving party does not need to have an active fax machine or phone line to receive fax images from a sending fax machine.

This reliance on email system as a delivery mechanism for fax reduces the overall effectiveness of the fax process. First, because the receiver simply receives an image of the sent document, modern computer graphics programs can be easily used to alter the fax image, easily destroying document (underlying message) integrity, thus faxed images using the T.37 method cannot be relied-on as original. Second, relying on email as a secondary system for delivery removes the possibility of receiving a document if the receiver is not using email; and third, T.37 is clearly not designed for use as a machine to machine transmission of document images (facsimiles), where the sender places and image in a sending machine and the document is automatically forwarded and printed on the receiving machine without user intervention, and is not an effective technology for doing so.

Thus, it is desirable to provide a universal document exchange system and method that overcomes the limitations of the conventional systems and the current system's reliance on the email system as a delivery mechanism, and it is to this end that the present invention is directed.

### SUMMARY OF THE INVENTION

A universal document exchange system and method (“UDX”) are provided. The system has a centralized, internet-based document exchange server which routes Internet-based faxes to various machines and servers on the Internet. The UDX architecture provides a vast technical improvement over current methods for routing T.37 based FAX documents, electronic images and files, resulting in a logical and user-friendly system.

The system in accordance with the invention solves the limitations of conventional systems by creating a simple, centralized architecture for a network of worldwide Internet-based facsimile machines. The system provides a highly simplified setup—in many cases, the user only has to plug the machine in. The system also permits the familiar use of Numeric character addressing—“UDX Direct” so that rather than entering an alpha-numeric email address into a fax machine, the receiver is assigned UDX Number (UDX Direct) which can be quickly typed by the sender into a keypad just like a conventional FAX number. The system may also provide a direct, machine to machine, real-time document transfer with immediate confirmation with a central server. The system may also provide document encryption by default with no setup required. The system also ensures backward compatibility in that it allows “UDX Compatible Machines” to dial-up another machine conventionally and then switch to UDX mode if both machines are compatible or remain in standard FAX mode if not. In total, these advantages eliminate the cumbersome elements of current i-FAX (T.37) technology and introduce the simplicity needed to create a new and powerful marketing component for FAX equipment manufacturers and ultimately, mass adoption for a new technology in the marketplace.

The system may provide several different modes of operation that may include a passive mode and a direct mode. In the passive mode (which may be free to the user), the customer can choose the system with an existing phone line in which a UDX enabled transmission starts by dialing a conventional facsimile number. In the passive mode, the UDX-enabled machine may automatically switch to Internet transmissions after a receiving machine ID has been communicated. In the direct mode, a user may register a “UDX Direct” number and the system permits direct transmissions to that machine from another UDX-enabled machine without any user of telephone lines. In a preferred embodiment, the “UDX Direct” number may be a ten digit (telephone number like) number.

A document exchange apparatus is provided. The document exchange apparatus comprises a sending machine having a sending identifier, a receiving machine having a receiving identifier and a central document exchange unit connected to the sending machine and the receiving machine by a network. The central document exchange unit further comprises a brokering unit that establishes a connection over the network between the sending machine and the receiving machine based on the sending identifier, the receiving identifier and one or more messages exchanged between the central document exchange unit and the sending and receiving machines. The central document exchange unit also has a communications unit that establishes one of a passive communications and a direct communications between the sending machine and receiving machine over the established connection wherein a document is exchanged between the sending machine and receiving machine over the established connection.

### BRIEF DESCRIPTION OF THE DRAWINGS

FIG. 1 is a diagram illustrating an example of a business model for a universal document exchange system in accordance with the invention;

FIG. 2 is an architectural diagram of a preferred embodiment of a universal document exchange system in accordance with the invention;

FIG. 3 is a diagram illustrating an example of a sending machine in accordance with the invention;

FIG. 4 is a diagram illustrating an example of a receiving machine in accordance with the invention;

FIG. 5 illustrates a method for machine set-up in accordance with the invention;

FIG. 6 illustrates a method for advanced brokering in accordance with the invention;

FIG. 7 illustrates a method for sending/receiving an electronic document in a passive mode in accordance with the invention; and

FIG. 8 illustrates a method for sending/receiving an electronic document in a direct mode in accordance with the invention.

### DETAILED DESCRIPTION OF A PREFERRED EMBODIMENT

The invention is particularly applicable to a computer-based universal facsimile document exchange system and method and it is in this context that the invention will be described. It will be appreciated, however, that the system and method in accordance with the invention has greater utility since the system may be used for various types of documents, such as electronic files or images, that are within the scope of the invention.

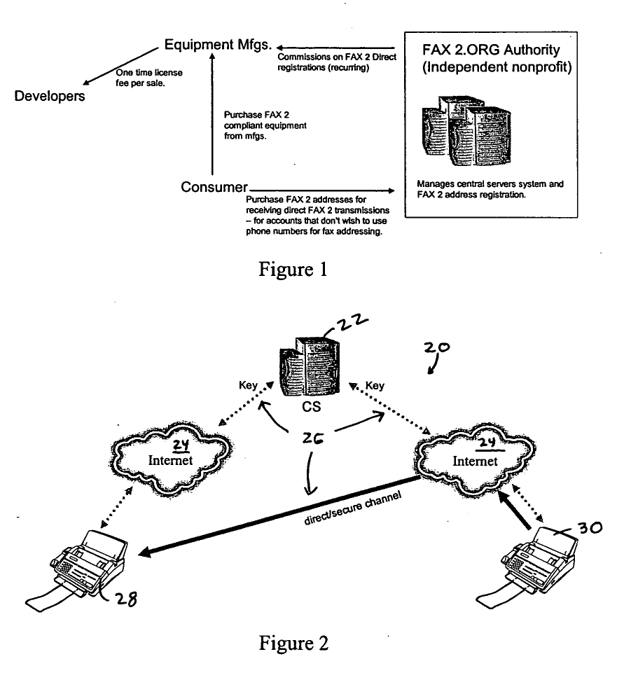

The document exchange system and method in accordance with the invention incorporates a business model. FIG. 1 illustrates an example of a business model for a universal document exchange system in accordance with the invention. The universal document exchange system may incorporate a two stage business strategy. First, the system may initially coexist and interface with the current telephony based FAX standard in order to encourage manufacturers to produce dual-enabled machines which can be used for conventional faxes as well as UDX. Second, a business model is created which is both non-threatening to FAX Equipment Manufacturers and clearly in-line with their interests.

In a preferred embodiment of the system, a non-profit organization may be created (shown as FAX2.ORG in FIG. 1). As has been proven in the past, it is rare that manufacturers will support a standard controlled or owned by a competitor or even a third party organization. For this reason, control of all central UDX operations may be relegated to a nonprofit organization, UDX.ORG. This organization will maintain central servers and set pricing for specific services (primarily UDX Direct Registrations) and bill end-users that use those services. The charter for the nonprofit will be to serve the customers and manufacturers by delivering the highest quality service at the cost of providing those services (Unlike a for-profit company whose primary purpose it to maximize shareholder value). In more detail, the non-profit organization may own and operate the central server system which provides routing information for UDX transmissions worldwide. The central server system may operate much like the Internet's DNS system, though registration and use will be much easier. The non-profit may also enable UDX Direct Registrations in which UDX machine addresses which allow users to send faxes directly to a machine without using a phone line or email address.

The non-profit may also align the interests of the parties. This alignment of interests between the formal non-profit organization and the other stakeholders in the system (customers and manufacturers) is key to establishing a non-competitive or threatening relationship with the manufacturers. The individual or business entity who owns the rights to UDX technology, possibly with the help of donations from leading manufacturers, will fund the nonprofit through a period of negative cash flow until the nonprofit is self sustaining. The UDX.ORG board will consist or representatives from the owner and the leading fax manufacturers.

As shown in FIG. 1, in return for creating the technology, infrastructure enabling UDX, the owner (shown as the Developer in FIG. 1) may receive licensing fees from the manufactures for machines sold utilizing the UDX technology. The current target is for $3-5 per UDX enabled fax unit sold, $1 per account for UDX enabled servers up to 10 accounts, 75 cents per account up to 50 accounts and 25 cents for each additional account. In addition, The Developer may receive an additional $1 per year per UDX Direct registration.

So that UDX machines will operate out of the box, UDX.ORG will not charge for Passive Mode servers even though the UDX central server (operated by UDX.ORG) is necessary to connect Passive Mode transmissions. UDX will, however, charge a small annual fee for UDX Direct number registrations of $15-20 per year. Approximately $5 per year of each registration will be paid to the manufacturer as commission and approx. $1 will be paid in licensing fees to the Owner of the Invention. Over time, UDX may choose to offer other non-competing services as well.

FIG. 1 illustrates the basic business model for the invention where the operational business unit (OBU) of the UDX system, shown as the Fax2.ORG Authority 10, manages the central server (described below), customer (shown as consumer) 22 relationships for those customers using the system, and tracks usage for registrations according to the manufacturer 12 of the consumer's equipment that is enabled by the manufacturer 12 to use the universal document exchange system. For practical purposes of this description, the manufacturer 12 could represent the actual manufacturer of the system, a partial manufacturer of the system or simply a branded distribution partner in the value chain product creation and distribution. The manufacturer 12 represented has significant control in determining product design and can influence whether or not to enable the consumer's equipment 11 with the UDX technology.

The consumer 11 pays the OBU for using the system. The OBU 10 can then compensate the manufacturer 12, according to the amount of usage that the customer 11 performs utilizing the UDX system. By compensating the manufacturer, manufacturers are compelled to create UDX enabled equipment and to sell that equipment in the marketplace. For the manufacturer 12 to receive compensation, the system must be able to identify the manufacturer utilizing a manufacturer ID described below. The developers 13 receive one time fees for registration from the manufacturers 12 or can receive licensing payment from the OBU 10. Now, the overall architecture of the universal document exchange system in accordance with the invention will be described in more detail.

FIG. 2 is a diagram illustrating an example of a preferred embodiment of the architecture of a universal document exchange system 20. The system may comprise a central computer 22, such as a typical server) that is connected to a computer network 24, such as the Internet, over which the central computer communicates data 26, that may be a message, commands, a brokering protocol, etc., with a sending document machine 28 and a receiving document machine 30. The central computer may be known as a central document exchange unit. In a preferred embodiment, the network communications may use TCP/IP as a network communications protocols, however, the invention can use other protocols such as UDP when appropriate, to accomplish the same communication tasks.

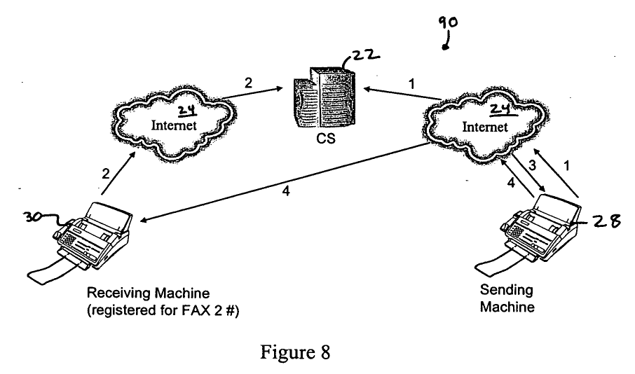

The distinction between the sending machine 28 and the receiving machine 30 is made to facilitate the explanation of the universal document exchange (UDX) transmission methods and techniques. However, similar to current FAX technologies in which a sending machine can also have the same ability described herein to “receive” fax transmissions and the “receiving machine can also have the same ability described herein to “send” fax transmissions. Thus, it assumed that, if each machine is so equipped, the method described is reversible and that a fax document could be transmitted either from the sending machine to the receiving machine or from the receiving machine to the sending machine. As shown, the communications between the central computer, sending machine and receiving machine may include brokering transactions (shown as dotted lines in FIG. 2) and secure transmissions (shown as a solid line in FIG. 2.) For example, the central computer 22 and the sending computer 28 may exchange keys to establish a secure communications link. Similarly, the central computer 22 and the receiving computer 30 may exchange keys to establish a secure communications link. In addition, if the direct mode of operation in being used (See FIG. 8 for more details of the direct mode), the sending machine 28 and the receiving machine are able to establish a direct secure communications channel between each other to communicate the documents with each other. The central computer 22 manages the operation of the system and manages the address registrations of the users of the system.

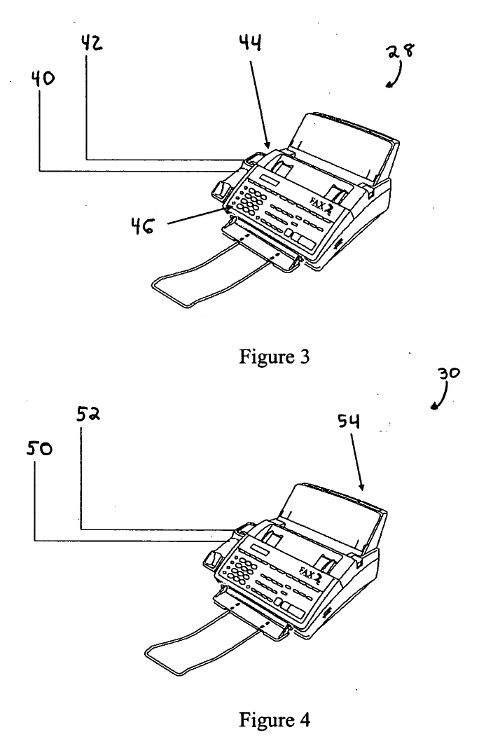

FIG. 3 illustrates more details of the sending machine 28. The sending machine may be a typical facsimile machine (having a processor, temporary memory, such as RAM, a permanent memory, such as flash memory or another persistent storage device, and software that operates together to provide the usual facsimile transmission and reception functions.) For example, the sending machine 28 may include a modem 40 which connects to a standard switched telephone network (POTS) although this element is not necessary for UDX Direct transmissions as described below, a network interface 42 which is capable of connecting the sending machine 28 to a computer network, either directly via a network connection such as through an Ethernet card installed in the sending machine or indirectly via a connection to a PC (such as a USB connection not shown) which is connected to said computer network, such as the Internet, a document scanner 44 for scanning and digitizing documents, a keypad 46 and a processor (not shown.) The sending machine 28 may further comprise one or more pieces of software (or software modules) that are executed by the processor to implement the UDX functionality.

FIG. 4 illustrates more details of the receiving machine 30. Similar to the sending machine, the receiving machine 30 may be integrated into a typical facsimile machine that has the elements above and further may comprise a modem connected to a POTS connection (not necessary for receiving UDX Direct transmission), a network interface 52 which is capable of connecting the sending machine 30 to a computer network, either directly via a network connection such as through an Ethernet card installed in the sending machine or indirectly via a connection to a PC (such as a USB connection—not shown) which is connected to said computer network, such as the Internet, and an output device or program 54. FIG. 4 shows an attached printer (part of a typical facsimile machine), however, the receiving machine 30 may optionally contain a computer program which associates a UDX Direct number with an email address, attaches FAX images to an email and forwards this email to that email address. Thus, the receiving machine 30 may further comprise one or more pieces of software (or software modules) that are executed by the processor to implement the UDX functionality.

In a preferred embodiment, the sending machine 28 and receiving machine 30 may both have a permanent memory into which a unique identifier (a unique non-IP address identifier) may be stored wherein the unique identifier uniquely identifies the particular sending or receiving machine. Preferably, the unique identifier may be shipped to a customer/user with the unique identifier already stored in the memory. The unique identifier may also include a manufacturer identifier that uniquely identifies the manufacturer of the particular machine so that, for example, the manufacturer may be compensated when a user/customer uses his machine to perform a document exchange. In the preferred embodiment, each machine may also be shipped with the software that is needed to operate with the universal document exchange system using the unique identifier and the manufacturer identifier.

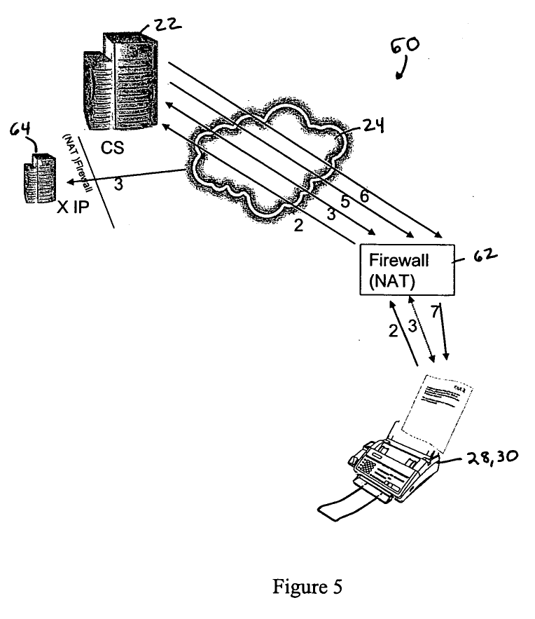

FIG. 5 illustrates a method 60 for machine set-up in accordance with the invention. In particular, every receiving-capable UDX machine (such as sending machine 28 or receiving machine 30) has a machine-specific FAX ID Number (FID number) which is hard coded into the machine's permanent memory during production by the manufacturer. The FID contains at least a unique machine identifier and a common manufacturer identifier. In a preferred embodiment of the invention, the central computer has a set-up unit that comprises one or more pieces of software that implement the set-up process in accordance with the invention.

In a first step of the set-up method, the UDX-enabled machine 28, 30 is plugged into an electrical outlet and a local LAN (behind a network address translation (NAT) server 62). The setup procedure is automatically initiated and the UDX machine searches for a Dynamic Host Configuration Protocol (DHCP) server and is issued an internal IP address. If a manual setup with/without a NAT server is done, the user may manually input an IP address, subnet mask and a domain name system (DNS) server. In a second step (see step 2 in FIG. 5), once the machine has established a network connection, whether through DHCP or manual settings, the UDX machine then sends a TCP/IP port 80 “initialize” request to the central computer (CS) 22. In a preferred embodiment of the invention, the network address of the central computer 22 is hard-coded in the UDX machine's permanent memory during production by the manufacturer. This initialize request includes the FID Number (stored in the permanent memory of the UDX enabled machine), a local LAN IP (internal) address and an Internal Port number (Target Port) of the machine. In addition, the CS 22 may create a data record (in a table or database associated with the central computer) for the machine in a master routing table (known as a master record) at the central computer. This data record includes the FID number of the machine so the machine can be recognized in any future communication with the CS.

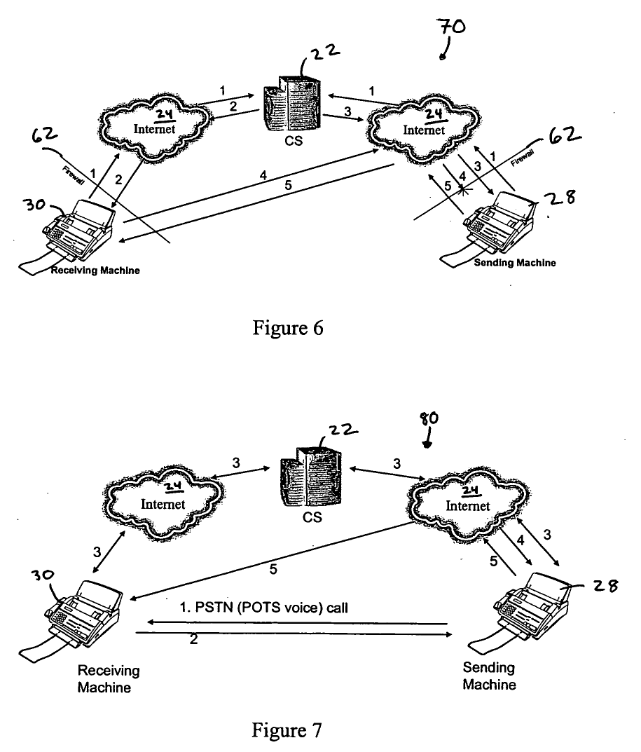

In a third step (see step 3 in FIG. 5), the CS 22 then runs a brokering test with a third-party external IP address 64 (noted in the illustration as “X IP”) through a NAT firewall (shown as a line in FIG. 5) to see if communication can be brokered through the firewall. Further details of this brokering are described below with reference to FIG. 6. In a fourth step (not shown in FIG. 5), if the machine is connected directly to the WAN (Internet) with its own IP address, the CS will flag the master record for that machine, identifying that machine as “Open.” If the brokering test is successful and the machine can be communicated with directly, then the UDX machine is considered initialized and ready and the CS 22 notes in the master record identifying that the machine is “Negotiable.”

If the brokering test is unsuccessful and the machine cannot be communicated with directly, then the CS 22 notes in the master record identifying that the machine is “Non-Negotiable.”

In a fifth step (shown as step 5 in FIG. 5), if the machine is not connected directly to the WAN (Internet) and the master record at the CS reflects that the machine is “Non-Negotiable,” the CS then proceeds to test to determine an ‘unavailable’ external port on the machine's NAT 62 (an unavailable port is an external port on the NAT that has not been mapped to an address internally on the LAN.) Upon finding an unassigned port, the CS 22 records this port in the master record and identifies the machine in the master record as “Mapped.”

In a sixth step (step 6 shown in FIG. 5), the UDX machine is then programmed (remotely by the CS 22) to use the target port and prints instructions for user to open the external port on the NAT/firewall and to map that port it to the FAX II machine's IP address internally on the LAN. In a seventh step (step 7 in FIG. 5), the user then must configure the local NAT to map the assigned port to the machine. If the port is not correctly set, then the user must go through the setup procedure again. Depending on the NAT, to avoid reconfiguring in the future, it might also be suggested that the user assign a permanent IP address to the UDX machine to be used to identify the machine inside the LAN.

Following this set-up method, the master record on the CS 22 for every enabled UDX machine identifies each machine as either:

“Open”—the machine has its own IP address and resides connected directly to the WAN (Internet)

“Negotiable”—The machine is behind NAT but a connection can be negotiated using Advanced Brokering (see below).

“Mapped”—the machine is behind NAT and the user has mapped an external port to the internal IP address of the machine.

Upon a reboot or restart, the initialization request of this method determines if port settings or machines local IP address have changed. If the address has changed, then the machine will be initialized using the same procedure as above, and, if the machine needs to be remapped, instructions will be automatically printed (the document is preferably hardcoded in the UDX firmware within the machine) for user to reassign the port number to the new internal IP address.

FIG. 6 illustrates a method 70 for advanced brokering in accordance with the invention. The advanced brokering method is a software enabled process that establishes a connection between a sending machine 28 and a receiving machine 30, both of which are behind NAT (firewalls) 62. The brokering process within the central computer may be part of a brokering unit of the central computer. A set of instructions passed between the CS 22 and Sending/Receiving Machines 28, 30 enable transmission of a fax from the sending machine 28 and receiving machine 30 when both machines are behind the NAT firewalls 62 and those NAT (firewalls) do not have manually configured ports in the firewalls which map to those machines. In the diagram, NAT 62 for each machine is shown as a straight line. When an arrow passes through the straight line, this represents a transmission that is allowed to pass through NAT. When a transmission (packet or set of packets) passes through NAT, it is translated appropriately according to well known NAT conventions and technology, and allows it to communicate with another device via the WAN or LAN respectively.

In a first step (shown as step 1 in FIG. 6), the CS 22 receives a transmission initiation request establishing a connection between the CS 22 and sending/receiving machines 28, 30. In a preferred embodiment, the receiving machine 30 uses a rarely used internal port, say port 4597 in its request. The CS 22 sets up a temporary “transaction data record” (TDR) (in its data table or database) and records the internal port number of the Receiving Machine (Target Port), MAC address of the Receiving Machine, the IP addresses, external port numbers of both machines and any other information which needs to be buffered and later forwarded.

In a second step (shown as step 2 in FIG. 6), the CS 22 then returns the IP address of the Sending Machine to the Receiving Machine. In a third step (shown as step 3 in FIG. 6), the CS returns the IP address, MAC address and internal Target Port of the Receiving Machine to the Sending Machine. The MAC address is not necessary for some firewalls, but might be necessary for others.

In a fourth step (shown as step 4 in FIG. 6), the receiving machine 30 sends a ‘False’ Request Packet to the Sending Machines using the internal Target Port. Though the packet is rejected by the firewall or NAT device of the Sending Machine (see FIG. 6 with the arrow that stops at the NAT 62), the firewall (NAT) of the Receiving Machine is now awaiting a response from the Sending Machine. This has, in effect, created a hole in the firewall. To be received, the IP address must be constructed appropriately with data in the packet.

In a fifth step (shown as step 5 in FIG. 6), after a short delay generated by the software on either the Sending Machine or the CS, the Sending Machine then constructs an acknowledgment packet using the IP address, Target Port and MAC address of the Receiving Machine and sends this as a response to the Sending Machine. Though the ‘False’ Request Packet (from step 4 above) never actually penetrated the firewall of Sending Machine, the Sending Machine's outbound response (acknowledgment) packet passes through the Sending Machine's firewall and is received through the open port that was established by the Sending Machine's False Request Packet. Standard NAT technology maps the packet to the Receiving Machine. When the Sending Machine sent a packet to the Receiving Machine through the Sending Machine's firewall, the firewall now considers the connection with the Receiving Machine legitimate and the connection is now established and the document can be exchanged between the machines.

While TCP uses ‘acknowledgements’ for traffic received and other communication packets, many of those well known transmissions are not shown or described herein. If UDP is used, there are no acknowledgment packets used, allowing the brokering to occur more simply. The diagrams and descriptions illustrate the primary components of the devices and communications that are necessary to conduct the document (file) transmission using the unique UDX architecture and software. The brokering process which establishes a connection between two machines behind firewalls will work in reverse as well—with the Receiving Machine receiving the IP address, MAC address and internal Target Port of the Sending Machine (in step 3) and the Sending Machine performing step 4 and Receiving Machine performing step 5. The advanced brokering works for transferring various types of files and information over a network and is not confined to fax type documents.

FIG. 7 illustrates a method 80 for sending/receiving an electronic document in a passive mode in accordance with the invention. The following describes how a UDX transmission is initiated using a plain old telephone line (POTS). This method allows the Receiving Machine to be enabled to receive both conventional modem-based faxes as well as receive faxes without a registered UDX Direct number (see direct mode below). In accordance with the invention, this passive communications mode may be implemented by a communications unit of the central computer. The communications unit of the central computer is preferably one or more pieces of software that implement the passive mode set forth below.

In a first step (shown as step 1 in FIG. 7), a PSTN call is made to the receiving machine 30 by the sending machine 28 and a modem connection is established. A UDX identifier request message is sent via modem from the sending machine 28 asking Receiving Machine for a UDX FID of the Receiving Machine—if no reply, assume Receiving Machine is not UDX compliant and continue with G3/G4 standard fax transmission. In a second step (shown at step 2 in FIG. 7), if Receiving Machine 30 responds and identifies itself as UDX enabled, a reply is sent to the sending machine 28 identifying the receiving machine 30 using the FID number.

In a third step (shown as step 3 in FIG. 7), the UDX state is set and both machines disconnect from the POTS connection and send an HTTP request to UDX central server. Then, the receiving machine 30 communicates, to the CS 22, details of the receiving machine's capabilities (i.e. JPEG compliant etc. Note all machines will be 1st generation compliant. Included details are only to detect mutually improved capabilities among machines. These capabilities might also be stored in the master record but is not a requirement for the invention to work). For a secure transactions, encryption keys can be forwarded to both the sending and receiving machines so that the sending machine can encrypt the documents to be sent and so that the encrypted documents can be read by the appropriate receiving machine using conventional public network encryption methods.

In a fourth step (shown as step 4 in FIG. 7), the CS 22 checks the master record of each machine to determine if one of the machines is registered as Open, Negotiable or Mapped. If either machine is either Open or Mapped, then the CS forwards the address and port information of the Open or Mapped machine to the second machine (this machine will be called “The Initiator”) which then initiates a direct connection through the WAN with the first machine. Once the connection is made, the Sending Machine sends the document/file to the Receiving Machine (via WAN). In the example shown in FIG. 7, the sending machine is the Initiator (receives the address of the Receiving Machine from the CS) implying that the Receiving Machine is either Open or Mapped. This does not have to be the case. In the instant that the Sending Machine is Open or Mapped, the CS could forward the address of the Sending Machine to the Receiving Machine and the Receiving Machine could initiate the direct communication and become the Initiator. It doesn't matter which machine initiates the communication as long as the communication channel is open for the necessary data/document/file transfer. If both machines are designated as either Open or Mapped in their data record then the CS can default to either machine as the Initiator. If both machines are identified in their master records as Negotiable, then the CS performs Advanced Brokering (described above with reference to FIG. 6) and brokers a handshake between the two machines, opening a communication channel between the two machines.

In a fifth step (shown as step 5 in FIG. 7), the sending machine 28 then forwards images directly to Receiving Machine using the appropriate addressing. Optionally, the receiving machine 30 responds after each successful page delivery and Sending Machine prints Send Report at completion of the FAX.

FIG. 8 illustrates a method 90 for sending/receiving an electronic document in a direct mode in accordance with the invention. In accordance with the invention, this direct communications mode may be implemented by the communications unit of the central computer and the communications unit may preferably comprises one or more pieces of software that execute the method set forth below. As described above, every UDX produced machine will have a machine specific hard-coded FID number and the owner of a UDX enabled machine will have the option of registering a UDX Direct number with the FAX.ORG Authority. This can be done by a customer using a user interface on the World Wide Web or by other means with a customer service agent. Upon registration, this UDX Direct number will be mapped to the FID of that machine in the master record for that machine on the CS. Thus, a Sending Machine can now send a packet request to the CS including the UDX address of the intended Receiving Machine. The CS checks the data record of the Receiving Machine. If the Receiving Machine is identified as either Open or Mapped, then the CS can initiate the transaction rather easily between the machines repeating techniques described in FIG. 7 above. However, one difference between Direct Mode and Passive Mode is that a machine identified in the master record as Negotiable that is set to receive UDX documents in Direct Mode must regularly send a packet request to (ping) the CS requesting if any documents are pending to be sent to that Receiving Machine. (For example: If this regular ping happens every 20 seconds creating an average latency of 10 seconds between when a UDX document is sent by a Sending Machine and when it is recognized as being sent by the Receiving Machine.)

In a first step of the method (shown at step 1 in FIG. 8), the sending machine 28 initiates a fax “send” to a registered UDX number. The CS 22 checks the master record of the Receiving Machine and the Receiving Machine is identified as Negotiable. The CS then creates a temporary “Attempting Send” data record including the UDX address of the Receiving Machine and the FID number of the Sending Machine. This send record may be active for a short period of time, maybe 30 seconds to 1 minute.

In a second step (shown as step 2 in FIG. 8), all Direct UDX enabled receiving hardware regularly pings (perhaps every 20 seconds) the CS to check for “Attempting Sends” to it UDX address(es). If an active send record is detected, then the CS responds to the ping request of the Receiving Machine with an acknowledgment of an Attempting Send.

In a third step (shown as step 2 in FIG. 8), the advanced brokering process described above is then implemented and the UDX central server initiates a handshake between machines. In a fourth step (shown as step 4 in FIG. 8), the sending machine 28 responds to the receiving machine's request with documents/files and images. The sending machine 28 may respond directly to the receiving machine 30 or passively through a relay connection using the CS (not shown.) Using a relay connection, the documents/files are uploaded to the CS 22 from the sending machine 28 and they reside temporarily at the CS 22 until retrieved from the CS 22 by request from the receiving machine 30.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for document exchange that identifies a sending machine and a receiving machine on a digital network and routes content between the sending and receiving machines, the system comprising:
a sending machine having a document scanning capability to digitize a scanned document into a digital data stream;
a receiving machine having a decoder that decodes the digital data stream so that the receiving machine is able to one of print and view the document;
a network that couples the sending machine, the receiving machine and a central computer to each other;
each sending machine and each receiving machine storing a unique non-IP address identifier wherein the unique non-IP address is communicated over the network to identify each sending machine and each receiving machine;
the central computer having a storage unit that stores an account for each sending machine and each receiving machine, the account containing the unique non-IP address of the one of the sending machine and receiving machine associated with the account so that a document from the receiving machine having the account is identified by the central computer; and
wherein the sending machine communicates the unique non-IP address identifier for the receiving machine to the central computer in order to initiate a document exchange transaction between the sending machine and the receiving machine.

2. The system of claim 1, wherein each of the sending machine and receiving machine further comprise a memory that stores the unique non-IP address.

3. The system of claim 1, wherein the account stored in the central computer further comprises one of a permanent account and a temporary account.

4. The system of claim 1, wherein the storage unit further comprises a database.

5. The system of claim 1, wherein the central computer further comprises a server.

6. The system of claim 1, wherein each account further comprises one of a business entity and user associated with one of the sending machine and the receiving machine.

7. The system of claim 1, wherein the storage unit also stores a direct number associated with each sending machine and each receiving machine so that a document exchange can be initiated using the direct number.

8. The system of claim 7, wherein the central computer receives a direct number from the sending computer, performs a look-up of the direct number in the storage unit to locate the associated unique non-IP address identifier of the receiving machine and routes the content onto the receiving machine using the unique non-IP address identifier of the receiving machine.

9. The system of claim 7, wherein the central computer further comprises a registration module wherein a user sets-up the account and associates the unique non-IP address identifier associated with the account with the direct number.

10. The system of claim 1, wherein unique non-IP address identifier further comprises a manufacturer identifier that identifies a manufacturer of one of the sending machine and receiving machine wherein the manufacturer identifier is used to track the usage of the system by one of the sending machine and receiving machine associated with the particular manufacturer.

11. The system of claim 10, wherein the central computer further comprises a metering unit wherein a manufacturer is compensated based on the manufacturer identifier.

12. The apparatus of claim 1, wherein the central computer further comprises a brokering unit wherein the brokering unit performs the steps of caching the digital data stream from the sending machine, looking-up the unique non-IP address identifier to identify the sending machine, receiving a request for the digital data stream from the receiving machine and looking up the unique non-IP address identifier to identify the receiving machine.
